(19) United States
(12) Patent Application Publication
(10) Pub. No.: US 2016/0103679 A1
(43) Pub. Date: Apr. 14, 2016

(54) SOFTWARE CODE ANNOTATION

(71) Applicant: Wolfram Research, Inc., Champaign, IL (US)

(72) Inventor: Stephen WOLFRAM, Concord, MA (US)

(21) Appl. No.: 14/880,961

(22) Filed: Oct. 12, 2015

Related U.S. Application Data
(60) Provisional application No. 62/062,647, filed on Oct. 10, 2014.

(51) Int. Cl. G06F 9/44; G06F 11/36

(52) U.S. Cl. CPC G06F 8/73; G06F 11/3608

(57) ABSTRACT

Software code is analyzed to identify one or more symbols in the software code, the one or more symbols corresponding to a defined software syntax. For each of one or more identified symbols: a corresponding annotation that conveys a meaning of the identified symbol is determined; a location within a document to display the annotation is determined so that the annotation, when displayed, is visually associated with the identified symbol; and the annotation is displayed at the location.

### CROSS-REFERENCE TO RELATED APPLICATION

The present application claims the benefit of U.S. Provisional Patent Application No. 62/062,647, filed on Oct. 10, 2014, entitled “Software Code Annotation,” which is incorporated by reference herein in its entirety.

### FIELD OF THE DISCLOSURE

The present application relates generally to user interfaces and, more particularly, to user interfaces that display annotations to software code.

### BACKGROUND

Software code writing and review of software code is difficult if a user is not experienced or not extremely familiar with a software language in which the code is written. Additionally, even experienced users familiar with the software language may be less familiar with certain infrequently used keywords or symbols. Further, some software languages correspond relatively strongly to particular natural language (e.g., English). As a result speakers of one natural language (e.g., Chinese) may have difficulties writing code or reviewing code written in a software language that corresponds relatively strongly to another natural language (e.g., English).

### SUMMARY OF THE DISCLOSURE

In an embodiment, a method includes analyzing, at one or more processors, software code in a document to identify one or more symbols in the software code, the one or more symbols corresponding to a defined software syntax i) that a computational application is preconfigured to recognize, and/or ii) that are defined by a software language. The method also includes, for each of one or more identified symbols, at one or more processors: determining a corresponding annotation that conveys a meaning of the identified symbol; determining a location within the document to display the annotation so that the annotation, when displayed, is visually associated with the identified symbol; and displaying the annotation at the location.

In another embodiment, a tangible, non-transitory computer readable medium, or media, stores machine readable instructions that, when executed by one or more processors, cause the one or more processors to: analyze software code in a document to identify one or more symbols in the software code, the one or more symbols corresponding to a defined software syntax i) that a computational application is preconfigured to recognize, and/or ii) that are defined by a software language. The machine readable instructions, when executed by one or more processors, also cause the one or more processors to, for each of one or more identified symbols: determine a corresponding annotation that conveys a meaning of the identified symbol, determine a location within the document to display the annotation on a display device so that the annotation, when displayed on the display device, is visually associated with the identified symbol, and cause the annotation to be displayed on the display device at the location.

In yet another embodiment, a system, comprises one or more processors, and one or more memories coupled to the one or more processors. The one or more memories store machine readable instructions that, when executed by one or more processors, cause the one or more processors to: analyze software code in a document to identify one or more symbols in the software code, the one or more symbols corresponding to a defined software syntax i) that a computational application is preconfigured to recognize, and/or ii) that are defined by a software language. The machine readable instructions, when executed by one or more processors, also cause the one or more processors to, for each of one or more identified symbols: determine a corresponding annotation that conveys a meaning of the identified symbol, determine a location within the document to display, on a display device, the annotation so that the annotation, when displayed, is visually associated with the identified symbol, and cause the annotation to be displayed on the display device at the location.

### BRIEF DESCRIPTION OF THE DRAWINGS

FIG. 1 is a block diagram of an example computing device configured to implement annotating techniques described herein, according to an embodiment;

FIG. 2 is a block diagram of an example system configured to implement annotating techniques described herein, according to an embodiment;

FIG. 3 illustrates an example document in which annotations are provided for software code, according to an embodiment;

FIG. 4 illustrates an example document in which annotations are provided for software code, according to an embodiment;

FIG. 5 illustrates an example document in which annotations are provided for software code, according to an embodiment;

FIG. 6 illustrates an example document in which annotations are provided for software code, according to an embodiment;

FIGS. 7A-C illustrate an example document in which annotations are provided for software code, according to various embodiments;

FIGS. 8A-C illustrate examples of non-textual visual annotations, according to various embodiments;

FIG. 8D illustrates an examples of a textual annotation for a non-textual symbol, according to an embodiment;

FIG. 9 illustrates various example user interface mechanisms for configuring annotations in a document, according to an embodiment; and

FIG. 10 is a flow diagram of an example method for annotating software code, according to an embodiment.

### DETAILED DESCRIPTION

In various embodiments described below, software code is automatically annotated to assist with code writing and/or code review, for example. For instance, in an embodiment, annotations for software code keywords that correspond with a first natural language are displayed, where the annotations are in a second natural language. As another example, software code annotations are displayed, where the annotations provide explanatory information with text and/or in non-textual, visual manner (e.g., using non-textual symbols). In some embodiments, annotations are based on a semantic and/or contextual analysis of the code, in contrast to a direct translation of keywords.

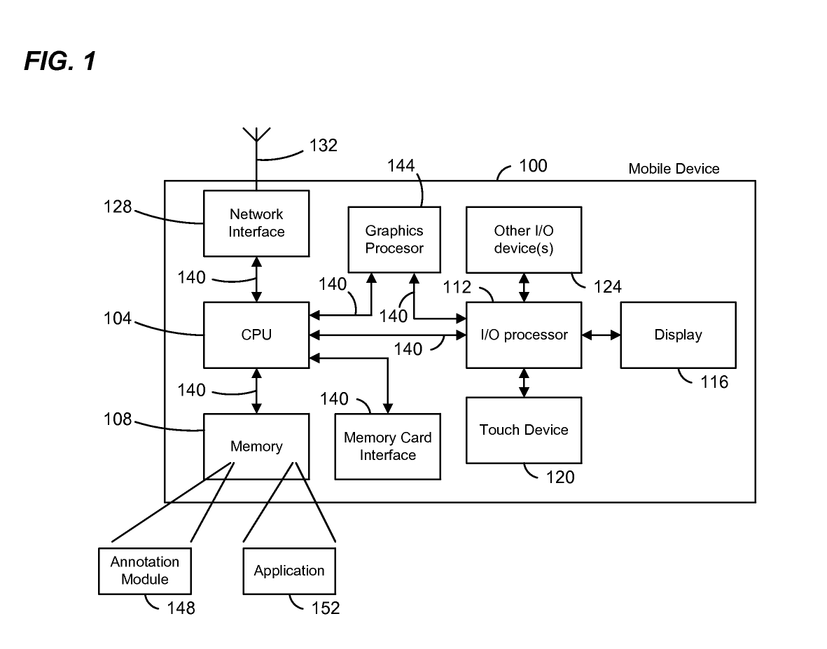

FIG. 1 is a diagram of an example mobile computing device 100 that may implement an annotation module configured to automatically annotate software code, according to some embodiments. The device 100 includes one or more central processing units (CPUs) 104 (hereinafter referred to as “the CPU 104” for purposes of brevity) coupled to a memory 108 (which can include one or more computer readable storage media such as random access memory (RAM), read only memory (ROM), FLASH memory, a hard disk drive, a digital versatile disk (DVD) disk drive, a Blu-ray disk drive, etc.). The device also includes one or more input/output (I/O) processors 112 (hereinafter referred to as “the I/O processor 112” for purposes of brevity) that interfaces the CPU 104 with a display device 116 and a touch-sensitive device or touchscreen 120 (e.g., a single-touch or multi-touch touchscreen). The I/O processor 112 also may interface one or more additional I/O devices 124 to the CPU 104, such as one or more buttons, click wheels, a keyboard, a keypad, a touch pad, another touchscreen (single-touch or multi-touch), lights, a speaker, a microphone, etc.

A network interface 128 is coupled to the CPU 104 and to one or more antennas 132. A memory card interface 136 is coupled to the CPU 104. The memory card interface 136 is adapted to receive a memory card such as a secure digital (SD) card, a miniSD card, a microSD card, a Secure Digital High Capacity (SDHC) card, etc., or any suitable card.

The CPU 104, the memory 108, the I/O processor 112, the network interface 128, and the memory card interface 136 are coupled to one or more busses 140. For example, the CPU 104, the memory 108, the I/O processor 112, the network interface 128, and the memory card interface 136 are coupled to a single bus 140, in an embodiment. In another embodiment, the CPU 104 and the memory 108 are coupled to a first bus, and the CPU 104, the I/O processor 112, the network interface 128, and the memory card interface 136 are coupled to a second bus. In other embodiments, more than two busses are utilized.

The device 100 also may include a graphics processor 144 coupled to the display 116 and to the CPU 104. The graphics processor 144 may be coupled to the display 116 via the I/O processor 112. The graphics processor 144 may be coupled to the CPU 104 and the I/O processor 112 via one or more busses 140.

The device 100 is only one example of a mobile computing device 100, and other suitable devices can have more or fewer components than shown, can combine two or more components, or a can have a different configuration or arrangement of the components. The various components shown in FIG. 1 can be implemented in hardware, one or more processors executing software or firmware instructions or a combination of both i) hardware and ii) one or more processors executing software or firmware instructions, including one or more integrated circuits (e.g., an application specific integrated circuit (ASIC)).

The CPU 104 executes computer readable instructions stored in the memory 108. The I/O processor 112 interfaces the CPU 104 with input and/or output devices, such as the display 116, the touch screen 120, and other input/control devices 124. Similarly, the graphics processor 144 executes computer readable instructions stored in the memory 108 or another memory (not shown) associated with the graphics processor 144. The I/O processor 112 interfaces the graphics processor 144 with the display 116 and, optionally other input/control devices.

The I/O processor 112 can include a display controller (not shown) and a touchscreen controller (not shown). The touchscreen 120 includes one or more of a touch-sensitive surface and a sensor or set of sensors that accepts input from the user based on haptic and/or tactile contact. The touchscreen 120 utilizes one or more of currently known or later developed touch sensing technologies, including one or more of capacitive, resistive, infrared, and surface acoustic wave technologies, as well as other proximity sensor arrays or other elements for determining one or more points of contact with the touchscreen 120. The touchscreen 120 and the I/O processor 112 (along with any associated modules and/or sets of instructions stored in memory 102 and executed by the CPU 104) can detect one or more points of or instances of contact (and any movement or breaking of the contact(s)) on the touchscreen 120, in some embodiments. Such detected contact can be converted by the CPU 104 into interaction with a user-interface mechanism that is displayed on the display 116. A user can make contact with the touchscreen 120 using any suitable object or appendage, such as a stylus, a finger, etc. In some embodiments, the touchscreen 120 includes force sensors that measure an amount of force applied by a touch. In such embodiments, an amount of force applied in connection with a contact can be utilized to distinguish between different user-requested actions. For example, a contact made with a relatively light touch may correspond to a first requested action (e.g., select an object), whereas a relatively forceful touch may correspond to a second requested action (e.g., select an object and open pop-up menu associated with the selected object).

The network interface 128 facilitates communication with a wireless communication network such as a mobile communications network, a wireless local area network (WLAN), a wide area network (WAN), a personal area network (PAN), etc., via the one or more antennas 132. In other embodiments, one or more different and/or additional network interfaces facilitate wired communication with one or more of a local area network (LAN), a WAN, another computing device such as a personal computer, a server, etc.

Software components or modules (i.e., sets of computer readable instructions executable by the CPU 104) are stored in the memory 108 and/or a separate memory (not shown) associated with the graphics processor. The software components can include an operating system, a communication module, a contact module, a graphics module, and applications such as a computational application, a data processing application, a software code editor, etc. The operating system can include various software components and/or drivers for controlling and managing general system tasks (e.g., memory management, etc.) and can facilitate communication between various hardware and software components. The communication module can facilitate communication with other devices via the network interface 128.

The contact module can detect contact with the touchscreen 120 (in conjunction with the I/O processor 112). The contact module can include various software components for performing various operations related to detection of contact, such as determining if contact has occurred, determining if there is movement of the contact and tracking the movement across the touchscreen 120 (in some embodiments), determining an amount of force in connection with the contact (in some embodiments), and determining if the contact has been broken (i.e., if the contact has ceased). Determining movement of the point of contact can include determining speed (magnitude), velocity (magnitude and direction), and/or an acceleration (a change in magnitude and/or direction) of the point of contact. These operations can be applied to single contacts (e.g., one finger contacts) or to multiple simultaneous contacts (e.g., “multi-touch”/multiple finger contacts), in some embodiments.

The graphics module can include various suitable software components for rendering and displaying graphics objects on the display 116. As used herein, the term “graphics” includes any object that can be displayed to a user, including without limitation text, web pages, icons, symbols, digital images, etc.

An annotation module 148 includes machined readable instructions that, when executed by one or more processors (such as the CPU 104 and/or the graphics processor 144), cause (i) the one or more processors to generate, and (ii) the display device 116 to display, annotations of software code.

In embodiments in which the CPU 104 executes at least portions of the annotation module 148, the annotation module 148 may be stored in the memory 108. In embodiments in which the graphics processor 144 executes at least portions of the annotation module 148, the annotation module 148 may be stored in the memory 108 and/or in another memory (not shown) of or coupled to the graphics processor 144. In some embodiments, the memory 108 is coupled to the graphics processor 144.

An application module 152, stored in the memory 108, may, when executed by the CPU 104, interact with the annotation module 148. For example, in embodiments in which the application module 152 is an application for performing computations and that provides a document in which a user can write and/or review software programming code to be executed and/or evaluated by the application module 152, the application module 152 may utilize the annotation module 148 to annotate the software programming code in the document. As another example, in embodiments in which the application module 152 is a software code editor and/or review application, the application module 152 may utilize the annotation module 148 to annotate the software programming code in a document. As yet another example, in embodiments in which the application module 152 is a spreadsheet application, the application module 152 may utilize the annotation module 148 to annotate spreadsheet keywords, symbols, etc. in a spreadsheet document.

Each of the above identified modules and applications can correspond to a set of instructions that, when executed by one or more processors, cause one or more functions described above to be implemented using the one or more processors. These modules need not be implemented as separate software programs, procedures or modules, and thus various subsets of these modules can be combined or otherwise re-arranged in various embodiments. For example, in some embodiments, the annotation module 148 is a component of the application module 152. In some embodiments, the memory 108 (and separate memory associated with the graphics processor, when included) stores a subset of the modules and data structures identified above. In other embodiments, the memory 108 (and separate memory associated with the graphics processor, when included) stores additional modules and data structures not described above.

In various examples and embodiments described below, computer displays and user interfaces are described with reference to the device 100 of FIG. 1 for ease of explanation. In other embodiments, another suitable device different than the device 100 is utilized to display computer displays and user interfaces. For example, other suitable devices include desktop computers, laptop computers, servers, computer gaming systems, cable television set top boxes, televisions, etc. Such other suitable devices may have a basic structure similar to the device 100 of FIG. 1.

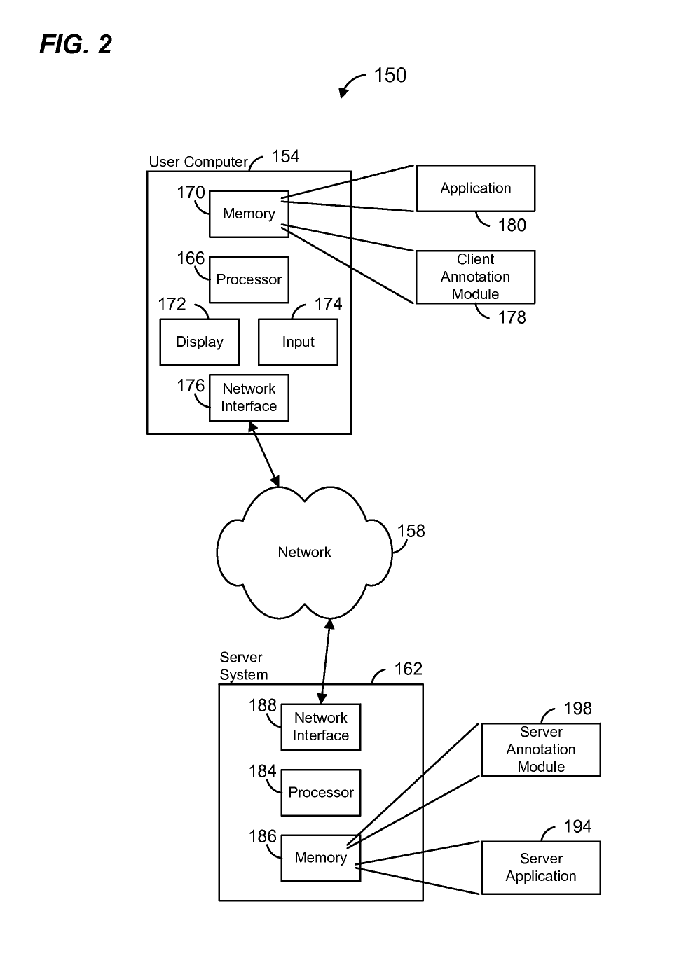

FIG. 2 is a diagram of an example system 150 which may implement annotation module configured to automatically annotate software code, according to some embodiments, according to some embodiments.

A user computer 154 is configured to implement a client annotation module alone, in one embodiment, or in conjunction with a server system 162, in another embodiment. In embodiments that include the server system 162, the user computer 154 is communicatively coupled to a communication network 158 including, for example, one or more of the Internet, an intranet, an extranet, a mobile communications network, etc., and the server system 162 is also communicatively coupled to the network 158. In embodiments that include the server system 162, the user computer 154 is configured to communicate with the server system 162 via the network 158.

The user computer 154 may be (or include) a computing device such as a desktop computer, a laptop computer, a tablet computer, a smart phone, a computer gaming system, a cable television set top box, etc. The user computer 154 may include one or more processors 166 (e.g., one or more CPUs, one or more coprocessors, and/or a graphics processor), one more memory devices 170 (e.g., random access memory (RAM), read only memory (ROM), FLASH memory, a magnetic disk, an optical disk, etc.), one or more display devices 172 (e.g., integral display device and/or external display device), and one or more input devices 174, such as a keyboard, a keypad, a button, a mouse, a trackball, a touch screen, a multi-touch screen, a touch pad, etc. The user computer 154 may include a network interface 176 to communicatively couple the user computer 154 to the network 158. At least some of the one or more processors 166 (hereinafter referred to as “the processor 166” for purposes of brevity), the one or more memory devices 170 (hereinafter referred to as “the memory device 170” for purposes of brevity), the one or more display devices 172 (hereinafter referred to as “the display device 172” for purposes of brevity), the one or more input devices 174 (hereinafter referred to as “the input device 174” for purposes of brevity), and the network interface 176 may be communicatively coupled together via one or more busses (not shown), cords (not shown), etc. In embodiments in which the user computer 154 comprises a set top box or a gaming system, for example, the display 172 may comprise a television communicatively coupled to the set top box or the gaming system.

The memory device 170 may store all or a portion of an annotation module 178. The annotation module 178, when executed by the processor 166, may cause (i) the processor 166 to generate and (ii) the display device 172 to display annotations of software code. As will be discussed in more detail below, the annotation module 178 may generate visual display information using information received from the server system 162, in some embodiments in which the server system 162 is included.

An application module 180, stored in the memory 170, may, when executed by the processor 166, interacts with the annotation module 178. For example, in embodiments in which the application module 180 is an application for performing computations and that provides a document in which a user can write and/or review software programming code to be executed and/or evaluated by the application module 180, the application module 180 may utilize the annotation module 178 to annotate the software programming code in the document. As another example, in embodiments in which the application module 180 is a software code editor and/or review application, the application module 180 may utilize the annotation module 178 to annotate the software programming code in a document. As yet another example, in embodiments in which the application module 180 is a spreadsheet application, the application module 180 may utilize the annotation module 178 to annotate spreadsheet keywords, symbols, etc. in a spreadsheet document.

In an embodiment, the application 180 may comprise a front end system that interfaces with a kernel implemented by the server system 162. In this embodiment, the front end system implemented by the user computer 154 may receive user input corresponding to functions commands, instructions, etc., and forward the user input to the server system 162. The kernel implemented on the server system 162 may then execute or interpret the entered functions, commands, instructions, etc., and perform corresponding numerical and/or symbolic calculations to generate corresponding results. The server system 162 may then transmit the results to the user computer 154, and the front end system implemented by the user computer 154 may then display the results in the electronic worksheet, spreadsheet, workbook, etc.

More generally, in some embodiments, the application 180 may comprise a client-side module that interfaces with a server-side module implemented by the server system 162. In some embodiments, the application 180 is a web browser. For instance, in one embodiment, the server system 162 may implement a computational application, and a user may utilize the computational application by way of a web browser application 180 implemented by the user computer 154. In this embodiment, the user computer 154 may receive user input corresponding to functions commands, instructions, etc. entered by the user by way of a web page that includes one or more user interface mechanisms for entering input related to a computation to be performed. In other embodiments, a web page corresponds to an electronic worksheet, a spreadsheet, a workbook, etc.

Input entered by the user is forwarded to the server system 162. The computational application implemented on the server system 162 may then execute or interpret the entered functions, commands, instructions, etc., and perform corresponding numerical and/or symbolic calculations to generate corresponding results. The server system 162 may then generate a web page to display the results, in an embodiment. In other embodiments, the server system 162 may generate an updated electronic worksheet, spreadsheet, workbook, etc., that includes the results. The results are transmitted by the server system 162 to the user computer 154. In some embodiments, the results are transmitted by the server system 162 to the user computer 154 as a web page, for example. A web browser implemented by the user computer 154 may then display the results. In some embodiments, a web page corresponds to an updated electronic worksheet, spreadsheet, workbook, etc., that includes the results.

The server system 162 may comprise one or more computing devices such as a desktop computer, a server, a mainframe, etc. The server system 162 may include one or more processors 184 (hereinafter referred to as “the processor 184” for purpose of brevity), one more memory devices 186 (e.g., RAM, ROM, FLASH memory, a magnetic disk, an optical disk, a database system, etc.) (hereinafter referred to as “the memory device 186” for purpose of brevity), and a network interface 188 to communicatively couple the server system 162 to the network 158. At least some of the processor 184, the memory device 186, and the network interface 188 may be communicatively coupled together via one or more of 1) one or more busses, 2) one or more networks (e.g., a local area network (LAN), a wide area network (WAN), etc.) 3) point-to-point communication links, 4) cords, etc. (not shown).

The memory device 186 may store a server application 194 that is executed by the processor 184. The server application 194 may comprise a web server application, a computational application, etc., in various embodiments.

In an embodiment, the server application 194 comprises a computational application that, when executed by the processor 184, may perform numerical, graphical, and/or symbolic calculations corresponding to functions, commands, instructions, etc., entered by the user in an electronic worksheet, spreadsheet, workbook, etc. For example, the server application 194 may execute or interpret the functions, commands, instructions, etc., received from the user computer 154, and perform corresponding numerical and/or symbolic calculations to generate corresponding results. In embodiments in which the server system 162 implements a kernel of a computational application, the server application 194 may cause the server system 162 to transmit the results to the user computer 154 via the network 158. In embodiments in which the server system implements a full computational application 194, which the computational application 194 may generate an updated electronic worksheet, spreadsheet, workbook, etc., that includes the results as a web page, for example, and may cause the server system 162 to transmit the web page to the user computer 154 via the network 158. In some embodiments, the system 150 utilizes systems and techniques such as described in U.S. patent application Ser. No. 14/549,541, filed Nov. 20, 2014, entitled “Methods and Systems for Cloud Computing,” which is incorporated by reference herein in its entirety. For example, in some embodiments, the server application 194 may correspond to, or include some functionality of, the cloud-based development system described in U.S. patent application Ser. No. 14/549,541.

The memory device 186 may store a server annotation module 198 that is executed by the processor 184. The server annotation module 198 may provide information for use by the client annotation module 178 in generating the visual display discussed above. For example, information generated by the server annotation module 197 may be transmitted by the server system 162 to the user computer 154. For example, the server annotation module 198 may provide information that, when utilized by the client annotation module 178 to generate annotation display information, in some embodiments. In some embodiments, the client annotation module 178 is omitted and the server annotation module 197 annotates documents directly, for example.

Illustrative examples are described below in the context of the MATHEMATICA® computational software application from WOLFRAM RESEARCH, INC. Thus, in some embodiments, the application module 152/180/194 comprises MATHEMATICA® and/or components thereof. As discussed above, however, the application module 152/180/194 may comprise another suitable application.

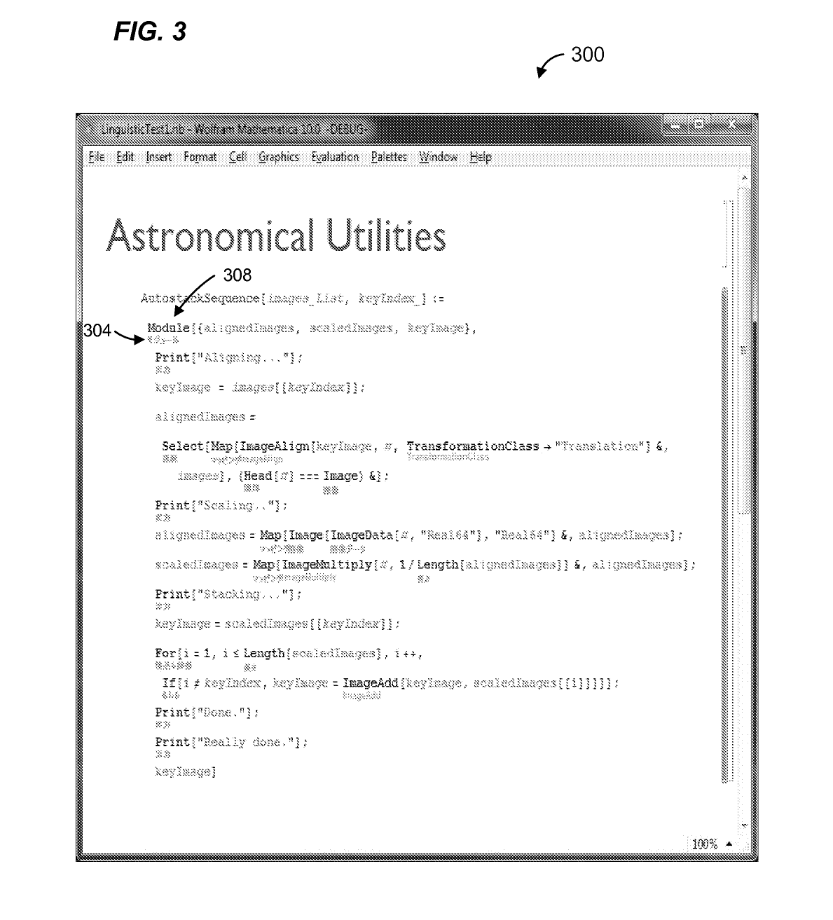

FIG. 3 illustrates a portion of an example MATHEMATICA® notebook 300, according to an embodiment. The notebook 300 includes code written in the WOLFRAM LANGUAGE™ software programming language. Additionally, the notebook 300 includes annotations expressed in the Japanese natural language. For example, an annotation 304 is displayed proximate to a keyword 308. The annotation 304 provides explanatory information, in textual form and in Japanese, relevant to the keyword 308. Additionally, the annotation 304 is displayed spatially proximate to the keyword 308 to visually indicate that the annotation 304 corresponds to the keyword 308.

In some embodiments, the annotation module 148/178/198 analyzes a document and, based on the analysis, determines which software code elements in a document are to be annotated, content of corresponding annotations to be displayed, and display locations at which the annotations are to be placed within the document when the document is displayed. Referring to FIG. 3, for example, the annotation module 148/178/198 analyzes the notebook 300 and, based on the analysis, determines that the keyword 308 is to be annotated, determines content of the annotation 304, and determines a location at which the annotation 304 is be placed when the notebook 300 is displayed.

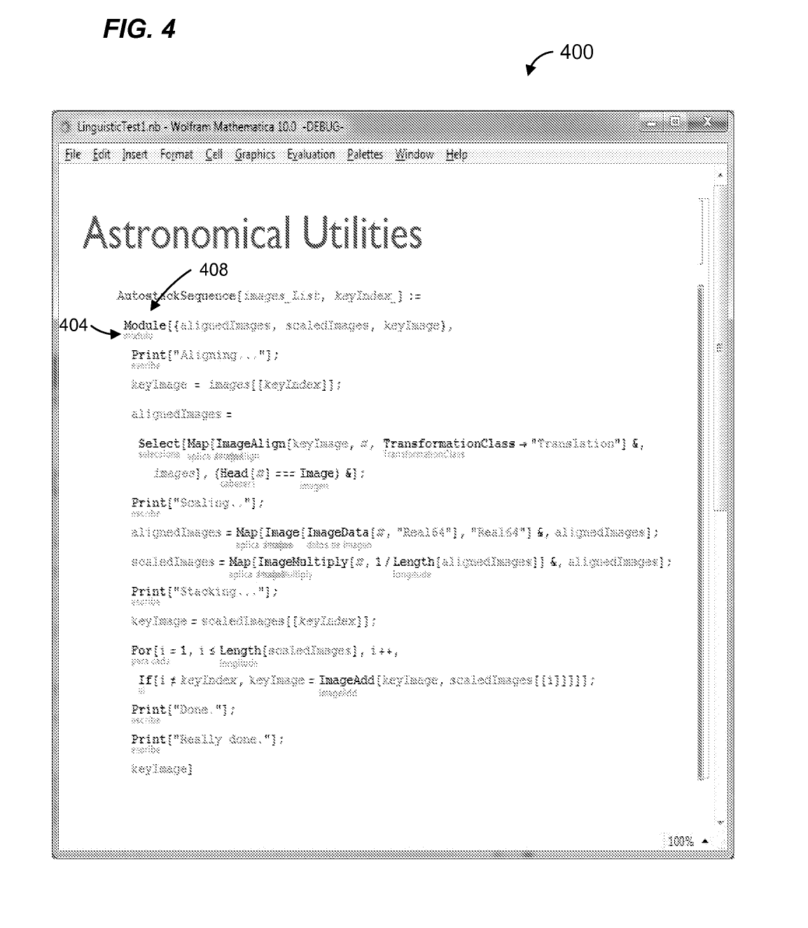

FIG. 4 illustrates a portion of another example MATHEMATICA® notebook 400, according to another embodiment. The notebook 400 includes code written in the WOLFRAM LANGUAGE™. Additionally, the notebook 400 includes annotations expressed in the Spanish natural language. For example, an annotation 404 is displayed proximate to a keyword 408. The annotation 404 provides explanatory information, in textual form and in Spanish, relevant to the keyword 408. Additionally, the annotation 404 is displayed spatially proximate to the keyword 408 to visually indicate that the annotation 404 corresponds to the keyword 408.

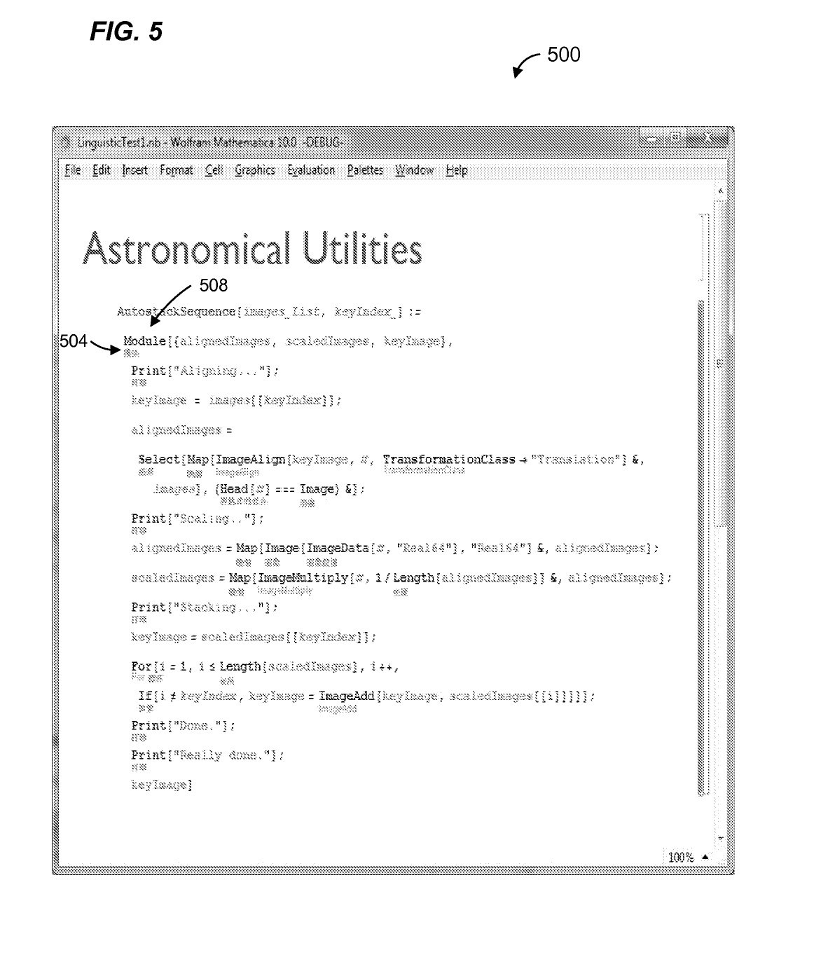

FIG. 5 illustrates a portion of another example MATHEMATICA® notebook 500, according to another embodiment. The notebook 500 includes code written in the WOLFRAM LANGUAGE™. Additionally, the notebook 500 includes annotations expressed in a Chinese natural language. For example, an annotation 504 is displayed proximate to a keyword 508. The annotation 504 provides explanatory information, in textual form and in Chinese, relevant to the keyword 508. Additionally, the annotation 504 is displayed spatially proximate to the keyword 508 to visually indicate that the annotation 504 corresponds to the keyword 508.

Although in FIGS. 3-5 each annotation is placed spatially proximate to the software code element to which the annotation corresponds, in other embodiments, at least some annotations are not displayed proximate to corresponding software code elements. For example, in an embodiment, the annotation module 148/178/198 is configured to determine a suitable location for an annotation that is spatially spaced apart from the software code element. For example, in an embodiment, the annotation module 148/178/198 is configured to determine a suitable location that is relatively free of software code elements (e.g., in a margin, in a portion of a line that is free of software code elements, etc.), display the annotation at the determined location, and then display a line, an arrow, a connector, etc., between the annotation and the corresponding software code element to show a correspondence between the annotation and the corresponding software code element.

In some embodiments, the annotation module 148/178/198 is configured to modify the document to allow for additional space in which to display annotations without obscuring other annotations and/or software code elements. For example, in some embodiments, the annotation module 148/178/198 is configured to add additional spacing between lines, add horizontal spacing between elements within a line, add blank lines between lines that include software code elements, etc.

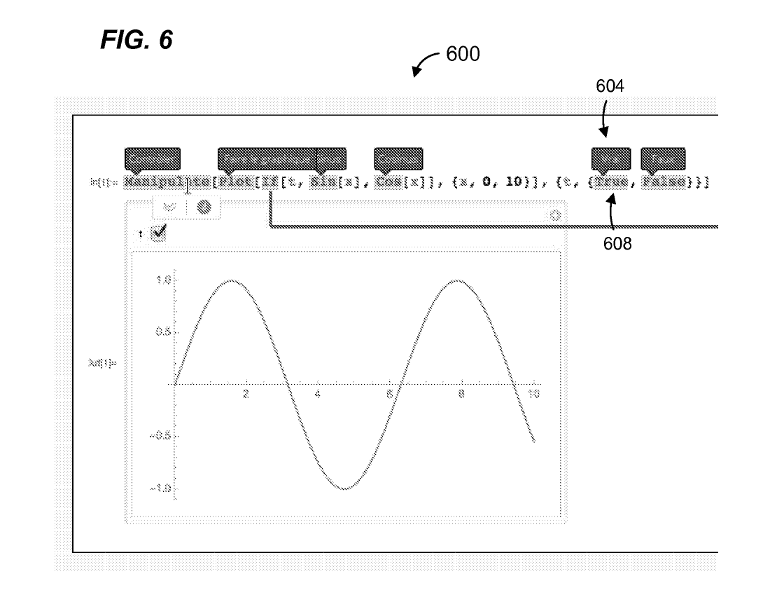

FIG. 6 illustrates a portion of another example MATHEMATICA® notebook 600, according to another embodiment. The notebook 600 includes code written in the WOLFRAM LANGUAGE™. Additionally, the notebook 600 includes annotations expressed in the French natural language. For example, an annotation 604 is displayed proximate to a keyword 608. The annotation 604 provides explanatory information, in textual form and in French, relevant to the keyword 608. Additionally, the annotation 604 is displayed spatially proximate to the keyword 608 to visually indicate that the annotation 604 corresponds to the keyword 608. Additionally, the annotation 604 includes a visual pointer to visually indicate, further, that the annotation 604 corresponds to the keyword 608.

As illustrated in FIGS. 3-6, annotations are displayed for keywords that correspond to functions, in some embodiments. For example, in an embodiment, annotations are displayed for keywords corresponding to built-in functions of the application module 152/180/194 (e.g., MATHEMATICA®, a spreadsheet application, etc.). As illustrated in FIG. 6, in some embodiments, annotations are displayed for keywords corresponding to arguments of functions (e.g., arguments “True” and “False” of the function “Plot”).

In some scenarios, a direct translation of a keyword from one natural language to another (e.g., English to German) results in a relatively long word or phrase. Similarly, in some scenarios, there is no direct translation of the keyword in the other natural language, or the direct translation does not provide accurate and/or adequate explanatory information regarding a functional purpose of the keyword in the software language. Thus, in some embodiments, a database of annotations is developed, where the annotations are designed to provide accurate and/or adequate explanatory information in one or more other natural languages regarding keywords. In some embodiments, the database of annotations includes annotations that provide accurate and/or adequate explanatory information in one or more other natural languages regarding software code symbols and/or other types of software code elements that are not keywords. In some embodiments, the annotation module 148/178/198 utilizes a suitable database of annotations, such as described above, to annotate software code.

In some embodiments, annotations are displayed for symbols and/or structures in the programming code that are not keywords. For example, in the context of MATHEMATICA®, the symbol “/@” corresponds to, and can be utilized in code instead of, a function with the keyword “Map”. Thus, in some embodiments, the symbol “/@” in software code is annotated as if the keyword “Map” were included in the code.

In some embodiments, annotations are displayed for keywords that can be utilized as arguments of functions. For example, in the context of MATHEMATICA®, the keyword “pi” corresponds to the mathematical constant 7E. Thus, in some embodiments, the symbol “pi” in software code is annotated using suitable techniques such as described herein.

In some embodiments, such as in the context of MATHEMATICA®, software code can include natural language words and phrases, and the application module 152/180/194 is configured to interpret the natural language words and phrases and utilize the interpretation in the software code. For example, in some embodiments, the application module 152/180/194 is configured to interpret natural language words and phrases corresponding to i) built-in functions of the software language and/or ii) software routines, and utilize the interpretations in the software code. See e.g., U.S. Pat. No. 8,589,869 (which is hereby incorporated by reference) and U.S. patent application Ser. No. 13/678,168, filed Nov. 15, 2012 (which is hereby incorporated by reference). Thus, in some embodiments, natural language words and/or phrases are annotated based on the interpretations using suitable techniques such as described herein.

In some embodiments, such as in the context of MATHEMATICA®, software code can include keywords and/or natural language words or phrases corresponding to known entities, such as countries (e.g., France), people (e.g., Albert Einstein), companies (e.g., General Electric), schools (e.g., University of Chicago), etc. Thus, in some embodiments, keywords and/or natural language words/phrases corresponding to known entities are annotated using suitable techniques such as described herein.

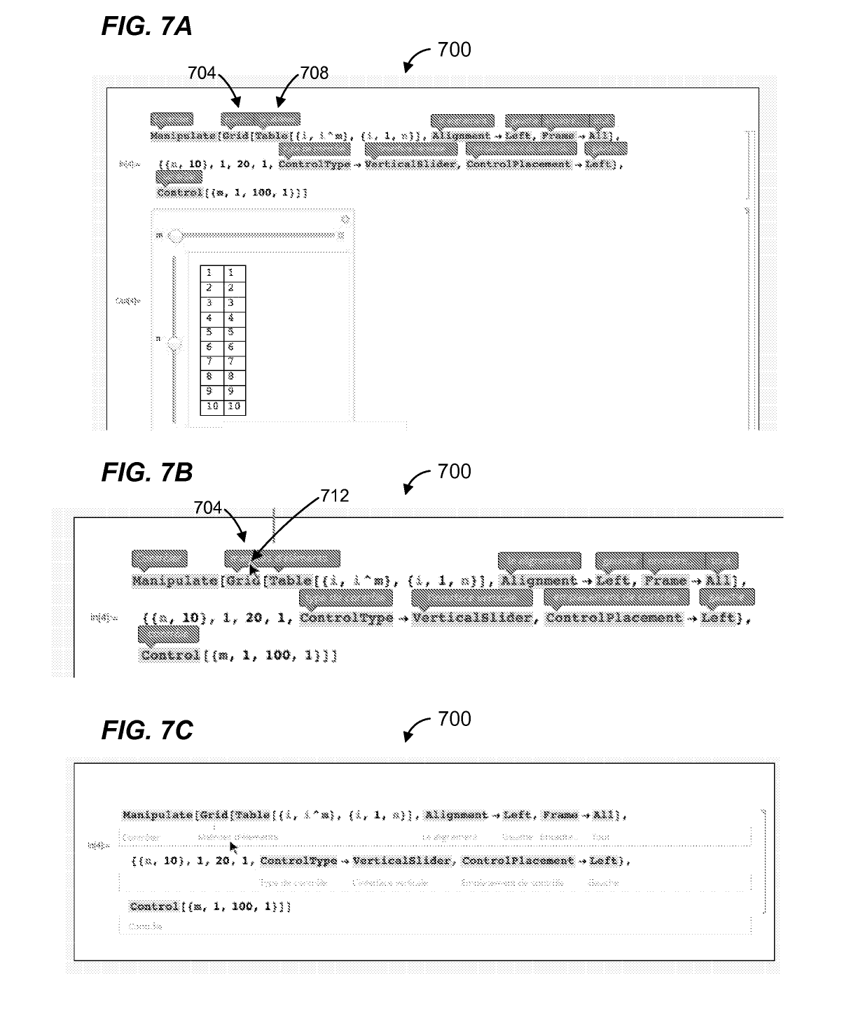

FIG. 7A illustrates a portion 700 of a document that is annotated with French language annotations, according to an embodiment. In the document 700, an annotation 704 generally overlaps with an annotation 708 at least partly because the corresponding keywords are adjacent. The entire annotation 704 is not fully displayed because if it were fully displayed, the annotation 704 would obscure the annotation 708. Thus, in some embodiments and/or scenarios, if display of an entire first annotation will obscure a second annotation, only a portion of the first annotation is displayed such that the second annotation is not obscured (at least not fully obscured) by the first annotation. In some embodiments, a user can see the entire annotation by taking an appropriate action with a user interface device (e.g., a mouse, a touchscreen, etc.). For example, FIG. 7B illustrates the document 700 after the user has moved a pointer icon 712 over the annotation 704, according to an embodiment. In response, the annotation module 148/178/198 causes the entire annotation 704 to be displayed, according to an embodiment. Subsequently, when the user moves the pointer icon 712 off of the annotation 704, the annotation 704 will be displayed as in FIG. 7A, according to an embodiment. In another embodiment, when a user touches the annotation 704 with a touchscreen, the annotation module 148/178/198 causes the entire annotation 704 to be displayed.

FIG. 7C illustrates another embodiment in which annotations as in FIGS. 7A and 7B have a different suitable visual format and placement with respect to corresponding keywords.

In some embodiments, the annotation module 148/178/198 is configured to determine a natural language (from a plurality of natural languages) in which the annotations are to be expressed. For example, in some embodiments, the annotation module 148/178/198 examines configuration information related to the application module 152/180/194 to determine a natural language (from a plurality of natural languages) in which the annotations are to be expressed. For example, the configuration information may indicate a country in which the application was purchased, and the annotation module 148/178/198 may determine the natural language for the annotations based on the country in which the application was purchased. As another example, the configuration information may indicate a natural language choice selected by the user, and the annotation module 148/178/198 may determine the natural language for the annotations based on the selected natural language. As another example, the configuration information may indicate a country in which the software is being used, and the annotation module 148/178/198 may determine the natural language for the annotations based on the indicated country.

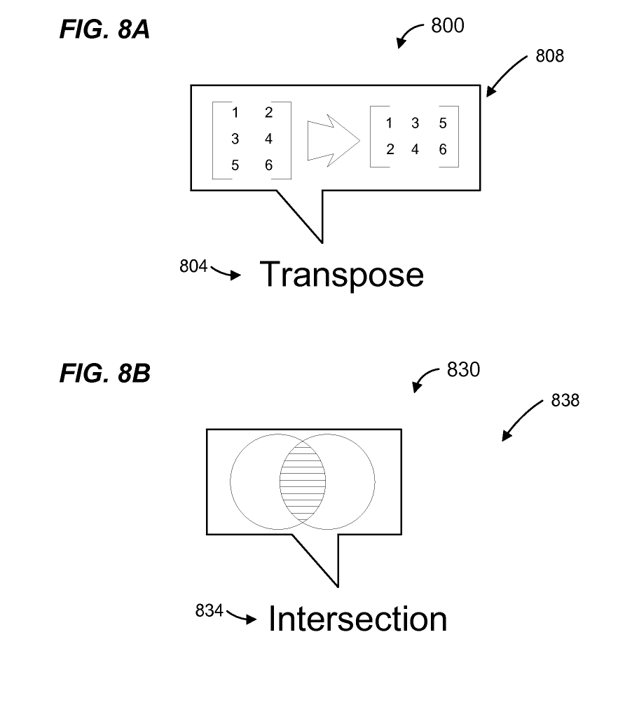

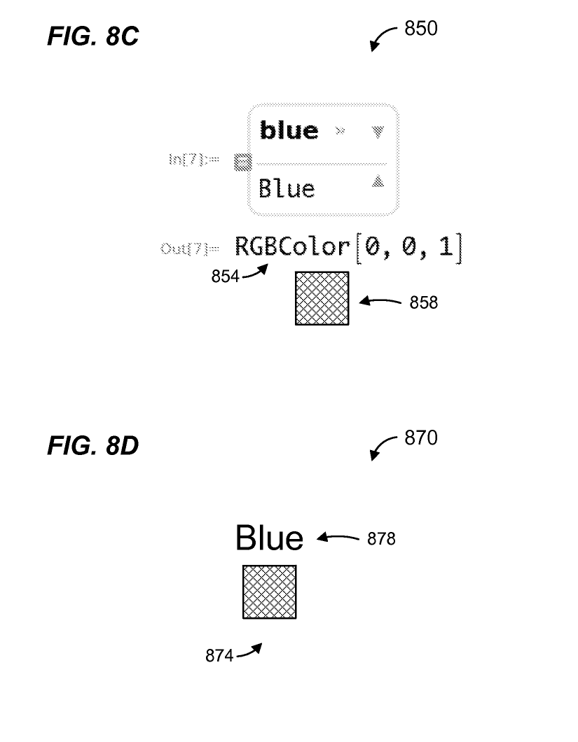

In some embodiments, at least some annotations provide information in a non-textual, visual form. For example, FIG. 8A illustrates a portion 800 of a document in which a keyword 804 (Transpose) is displayed. In an embodiment, the keyword 804 corresponds to a matrix transpose function. In this embodiment, an annotation 808 is displayed proximate to the keyword 804. The annotation 808 symbolically provides information about the function to which the keyword 804 corresponds. For example, the annotation 808 is a visual depiction of a matrix being transposed.

As another example, FIG. 8B illustrates a portion 830 of a document in which a keyword 834 (Intersection) is displayed. In an embodiment, the keyword 834 corresponds to a function for returning common elements in multiple lists. In this embodiment, an annotation 858 is displayed proximate to the keyword 854. The annotation 858 symbolically provides information about the function to which the keyword 854 corresponds. For example, the annotation 858 is a visual depiction of an intersection between two geometric shapes.

As another example, FIG. 8C illustrates a portion 850 of a document in which the user has activated a free-form linguistic input capability of MATHEMATICA®. The user has typed the word “blue” into and the application module determined that the input corresponds to the keyword Blue, which the application module recognizes as a color entity. In response, the application module outputs an RGB representation 854 of the color Blue. In an embodiment, an annotation 858 is displayed proximate to the keyword 854. The annotation 858 symbolically provides information about the function to which the keyword 854 corresponds. For example, the annotation 858 comprises a swatch of the color blue.

As yet another example, FIG. 8D illustrates a portion 870 of a document in which a color swatch 874 is displayed. The color swatch 874 could be part of a user interface, for example, prompting a user to select a color from a plurality of different colors (not shown), according to an embodiment. In an embodiment, an annotation 878 is displayed proximate to the color swatch 874. The annotation 858 explains in text the color that is displayed in the color swatch 874. This may be helpful, for example, for users with achromatic vision or other visual problems, or in environments or with display devices, etc., that make it difficult for the user to distinguish colors.

In some embodiments, the annotation module 148/178/198 provides annotations in the natural language of the user (or in a non-textual, visual form; see e.g., FIGS. 8A-8C) to provide explanatory information to the user regarding software code in a document. For example, novice users may utilize annotations for keywords, phrases, and/or symbols with which they are not yet familiar. As another example, advanced users may utilize annotations for particular keywords, phrases, and/or symbols, particular classes of keywords, phrases, and/or symbols, particular types of keywords, phrases, and/or symbols, etc., with which they are not yet familiar.

In some embodiments, the annotation module 148/178/198 is configured to determine a level of annotating to be provided, and to annotate a document according to the determined level. For example, in an embodiment, the annotation module 148/178/198 is configured to determine a skill level of a user and to determine an annotating level based on the determined skill level. In an embodiment, the annotation module 148/178/198 is configured to determine the skill level of the user based on configuration information. For example, the annotation module 148/178/198 may prompt the user (e.g., via a suitable user interface such as a graphical user interface (GUI)) to select a skill level from a set of potential skill levels, and then store an indication of the selected skill level as configuration information.

In an embodiment, the annotation module 148/178/198 is configured to determine the skill level of the user based on monitoring user interaction with the application module 152/180/194, historical information associated with user interaction with the application module 152/180/194. For example, in an embodiment, the application module 152/180/194 is configured to monitor a typing speed and to determine a skill level based on the determined typing speed. As another example, the application module 152/180/194 is configured to determine, based on historical use information, a cumulative amount of time the user has utilized the application module 152/180/194, and to determine a skill level based on the determined amount of time.

In some embodiments, the annotation module 148/178/198 is configured to determine whether annotations for particular keywords, phrases, symbols, etc., should be displayed based on historical information associated with user interaction with the application module 152/180/194. For example, in an embodiment, the annotation module 148/178/198 is configured to monitor, based on historical user information, how many times the user has utilized a particular keyword. In an embodiment, the annotation module 148/178/198 determines whether an annotation for the particular should be displayed based on how many times the user has utilized the particular keyword. For example, if a user has used a particular keyword many times, it may be assumed that the annotation for the keyword is no longer necessary and/or helpful to the user.

In some embodiments, the user may be permitted to configure annotating by turning OFF or ON annotations for particular keywords/phrases/symbols, particular types of keywords/phrases/symbols, particular classes of keywords/phrases/symbols, etc. For instance, in some embodiments, the application module 152/180/194 and/or the annotation module 148/178/198 may provide one or more user interface mechanisms to permit a user to turn OFF or ON annotations for particular keywords/phrases/symbols, particular types of keywords/phrases/symbols, particular classes of keywords/phrases/symbols, etc. As another example, in some embodiments, the annotation module 148/178/198 may be configured to display annotations in a plurality of natural languages, and the application module 152/180/194 and/or the annotation module 148/178/198 may provide one or more user interface mechanisms to permit a user to select a natural language for the annotations from the plurality of natural languages.

In various embodiments, an annotation is displayed when a user selects a keyword/phrase/symbol, hovers a mouse pointer over the keyword/phrase/symbol, etc. Similarly, in various embodiments, the annotation is no longer displayed when a user de-selects the keyword/phrase/symbol, moves the mouse pointer from over the keyword/phrase/symbol, selects another keyword/phrase/symbol to cause another annotation to be displayed, hovers the mouse pointer over the other keyword/phrase/symbol to cause the other annotation to be displayed, etc. In some embodiments, one or more annotations are no longer displayed in response to the user taking a user interface action such as selecting a particular keyboard key (e.g., the Escape key), selecting a button, etc.

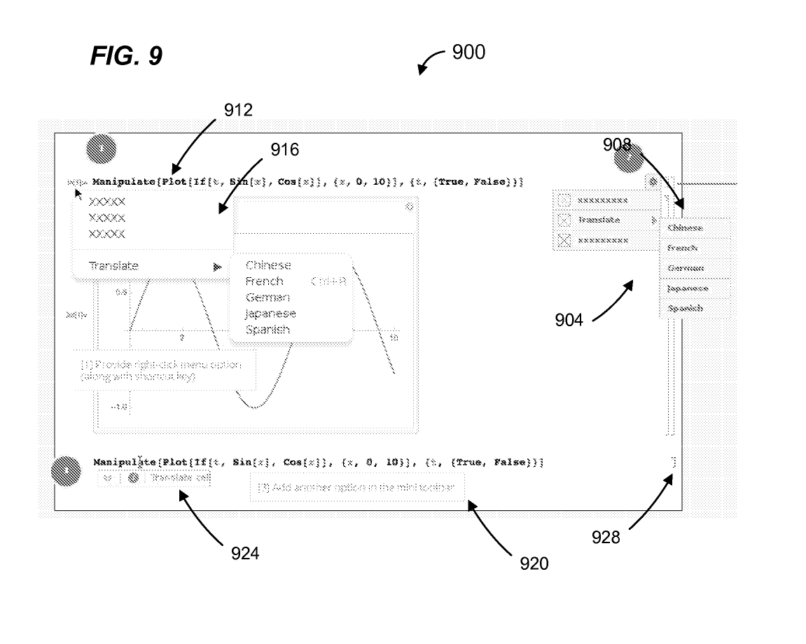

FIG. 9 illustrates an example document 900 with multiple example user interface mechanisms for configuring annotating, according to various embodiments. For example, in an embodiment, a user may be permitted to turn ON and OFF annotations and/or otherwise configure annotating for the entire document 900. In particular, a menu system 904 may be utilized to turn ON annotations and to select a particular natural language in which annotations are to be provided, according to an embodiment. The menu system 904 may be accessed by selecting a button 908, according to an embodiment.

As another example, in an embodiment, a user may be permitted to turn ON and OFF annotations and/or otherwise configure annotating for a particular portion of the document 900. For instance, the user may be permitted to turn ON and OFF annotations for a particular expression 912 (e.g., a particular line of code) in the document 900. In particular, a menu system 916 may be utilized to turn ON annotations and to select a particular natural language in which annotations are to be provided for the expression 912, according to an embodiment. The menu system 916 may be accessed, for example, by moving a cursor over the expression (or a particular portion of the expression, e.g., to the left of an equal sign) and then performing a right button mouse click, according to an embodiment.

As another example, in an embodiment, the user may be permitted to turn ON and OFF annotations and/or otherwise configure annotating for a particular section 920 (e.g., a particular cell of a MATHEMATICA® notebook, a particular sheet of a spreadsheet document) of the document 900. In particular, a menu system 924 may be utilized to turn ON annotations and to select a particular natural language in which annotations are to be provided for the cell 920, according to an embodiment. The menu system 924 may be accessed, for example, by moving a cursor over a visual marker 928 (e.g., a bracket) indicating the cell, and then performing a right button mouse click, according to an embodiment.

In some embodiments, the user may be permitted to turn ON and OFF annotations and/or otherwise configure annotating a document, a section of a document, etc., using keyboard shortcuts.

In some embodiments, the application module 152/180/194 may be configured to evaluate expressions in the document to generate results, and then include the results in the document. In some such embodiments, the annotation module 148/178/198 may be configured to provide annotations for results generated by the application module 152/180/194 to, for example, provide explanatory information regarding the results. For example, if a generated result includes a plot, the annotation module 148/178/198 may be configured to provide an annotation to provide explanatory information regarding the plot, such as the type of the plot (e.g., 2D, 3D, polar, scatter, etc.). As another example, if a generated result includes a keyword/phrase/symbol, the annotation module 148/178/198 may be configured to provide an annotation to provide explanatory information regarding the keyword/phrase/symbol.

In some embodiments, the application module 152/180/194 may be configured to analyze programming input in the document, and the annotation module 148/178/198 may be configured to utilize information resulting from the analysis by the application module 152/180/194 to, for example, determine what annotations should be provided, content of the annotations, etc. For example, in embodiments in which the application module 152/180/194 is configured to analyze natural language input and/or input in imprecise syntax, the annotation module 148/178/198 may be configured to utilize information resulting from the analysis of the natural language input and/or input in an imprecise syntax by the application module 152/180/194 to, for example, determine what annotations should be provided, content of the annotations, etc.

In some embodiments, the annotation module 148/178/198 may be configured to utilize context information and/or semantic information, and/or to perform a contextual analysis and/or a semantic analysis, to determine what annotations should be provided, content of the annotations, etc. For example, in some embodiments, the application module 152/180/194 may be configured to perform a contextual analysis and/or a semantic analysis on programming input to generate context information and/or semantic information, and the annotation module 148/178/198 may be configured to utilize the context information and/or the semantic information to determine what annotations should be provided, content of the annotations, etc. As an illustrative example, the term “block” may be utilized in programming input in a variety of contexts, such as to indicate a grouping (e.g., a block of data), to indicate an action (e.g., to block a signal), etc., and the annotation module 148/178/198 may be configured to utilize context information and/or semantic information to determine an appropriate annotation to provide for the term “block” within programming input in a document.

Similarly, in some embodiments, a built-in function of a programming language may perform differently when different arguments are provided to the function. As an illustrative example, the function Flatten in MATHEMATICA® generally flattens out nested lists. If only a list is provided as an argument to the function Flatten (e.g., Flatten[list]), the list is flattened at all levels. On the other hand, if a list parameter list, a level parameter n, and a head parameter h are provided as arguments to the function Flatten (e.g., Flatten[list, n, h]), the list is flattened up to level n, with respect to head h:

In[1]:=Flatten[f[g[u, v], f[x, y]], Infinity, g]

Out[1]=f[u, v, f[x, y]]

In[2]:=Flatten[f[g[u, v], f[x, y]], Infinity, f]

Out[2]=f[g[u, v], x, y]

Thus, in some embodiments, the annotation module 148/178/198 may be configured to provide different annotations for a keyword corresponding to a function when different arguments to the function cause the function to perform differently, for example.

In some embodiments, techniques described herein may be utilized in conjunction with techniques described in U.S. patent application Ser. No. 13/349,351, filed Jan. 12, 2012, which is hereby incorporated by reference. For example, in some embodiments, after the application module evaluates programming input to generate a result, the application module may be configured to generate one or more further operations to perform on the result. The annotation module 148/178/198 may be configured to provide annotations for one or more of i) the result, ii) the one or more further operations to perform on the result, and/or iii) further results generated in response to the user deciding to perform one or more of the suggested operations.

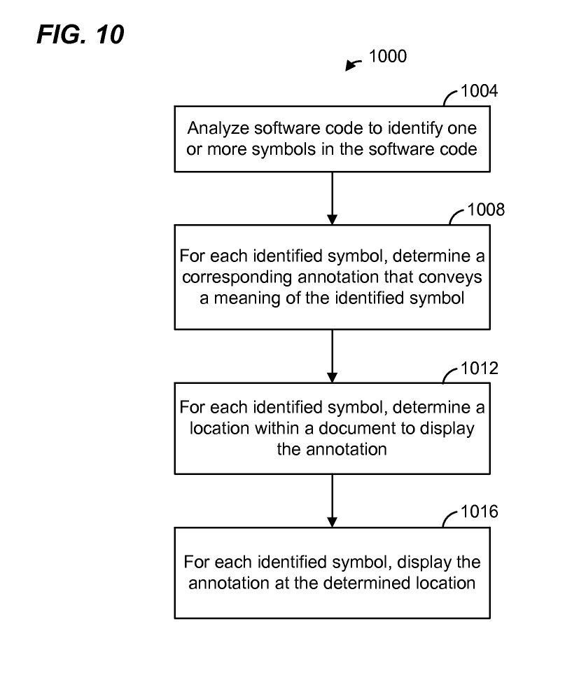

FIG. 10 is a flow diagram of an example method 1000 for annotating software code, according to an embodiment. The method 1000 may be implemented by the annotation module 148/178/198, and optionally in conjunction with the application module 152/180/194, in some embodiments. In other embodiments, the method 1000 may be implemented by other suitable systems.

At block 1004, software code is analyzed to identify one or more symbols in the software code. In various embodiments, the software code may be in a document such as a document in a format recognized by a computational application, a software editor, a software review application, etc. In some embodiments, the one or more symbols correspond to a defined software syntax that a computational application is preconfigured to recognize. In some embodiments, the one or more symbols correspond to a syntax defined by a software language (e.g., C, C++, Java, etc.). In some embodiments, at least some of the symbols comprise keywords, and the keywords comprise words and/or components of words from a first natural language (e.g., English or another suitable natural language). In some embodiments, at least some of the symbols comprise alphanumeric characters and/or combinations of one or more alphanumeric characters such that these symbols do not include words or recognizable word components from the first natural language.

At block 1008, for each of at least some of the symbols identified at block 1004, a corresponding annotation that conveys a meaning of the identified symbol is determined. In some embodiments, and for symbols that may have different meanings in different contexts, block 1008 may include performing a semantic analysis of at least a portion of the software code (e.g., a line of the code in which a symbol is included) and/or performing a contextual analysis of at least a portion of the software code to generate semantic and/or context information regarding the symbol, and utilizing the semantic and/or context information to one annotation from a plurality of possible annotations corresponding to the symbol.

In some embodiments, the annotation module 148/178/198 may include a database (e.g., a file, a table, a relational database, etc.) that associates symbols with corresponding annotations. In such embodiments, block 1008 may include utilizing the database to determine a corresponding annotation for an identified symbol.

In some embodiments, the database may include annotations corresponding to a plurality of natural languages (e.g., any suitable combination of two or more of Arabic, Chinese, Dutch, English, French, German, Greek, Hebrew, Hindi, Indonesian, Italian, Japanese, Korean, Persian, Portuguese, Russian, Spanish, Turkish, Urdu, etc.), and block 1008 may include selecting a natural language from the plurality of natural languages, and determining the annotation based on the selected natural language. In some embodiments, selecting the natural language from the plurality of natural languages may include analyzing configuration information corresponding to the application module 152/180/194, the configuration information indicating a natural language of a user of the application module 152/180/194.

At block 1012, for each of at least some of the symbols identified at block 1004, a location within a document to display the annotation is determined. In some embodiments, the location is determined so that the annotation, when displayed, is visually associated with the identified symbol.

At block 1016, for each of at least some of the symbols identified at block 1004, the annotation is displayed at the location determined at block 1012. In some embodiments, block 1016 includes determining whether a first annotation, when fully displayed at a corresponding first location, will visually overlap with a second annotation to be displayed at a second location. In such embodiments, when it is determined that, when fully displayed, the first annotation at the first location will visually overlap with the second annotation at the second location, only a portion of the first annotation is displayed at the first location so that display of the portion of the first annotation will not visually overlap with the second annotation at the second location. In some embodiments, block 1016 includes determining a size of the first annotation and determining whether the first annotation, when fully displayed at the corresponding first location, will visually overlap with the second annotation to be displayed at the second location based on the determined size of the first annotation.

In various embodiments, annotations may be displayed in the document in a color that is different than a color or colors in which software code is displayed (and/or other in which other content (e.g., comments) in the document is displayed) so as to visually distinguish the annotations from the software code and/or other content (e.g., comments) in the document. In some embodiments, annotations may be displayed in boxes or bubbles having a background color and/or pattern so as to visually distinguish the annotations from the software code and/or other content (e.g., comments) in the document.

In some embodiments, an annotation, when displayed, may include (or may also function as) a link to documentation regarding the symbol to which the annotation corresponds. The document to which the annotation provides a link may provide detailed information regarding the symbol in the second natural language, in an embodiment. Thus, in some embodiments, when a user selects the annotation with a user interface device, the annotation module 148/178/198 and/or the application module 152/180/194 may cause documentation information regarding the corresponding symbol to be displayed on the display device (or another display device). For example, in an embodiment, the annotation module 148/178/198 and/or the application module 152/180/194 may cause documentation information regarding the corresponding symbol to be displayed in a window.

In some embodiments, when multiple annotations corresponding to single symbol are determined at block 1008, the multiple annotations may be displayed (at least partially) at block 1016. For example, in an embodiment, multiple annotations are displayed so that they do not visually overlap and so that each annotation is visible. As another example, in an embodiment, multiple annotations are displayed so that they visually overlap so that only one annotation is fully visible, and so that only a portion of each other annotation is visible. For instance, when a user wishes to view an annotation that is not fully visible, the user may select the annotation with a user interface device, and the annotation module 148/178/198 and/or the application module 152/180/194 may cause the selected annotation to become fully visible.

In some embodiments, if an annotation is not found for an identified symbol at block 1012, no annotation is displayed at block 1016. In other embodiments, however, a “default” annotation is displayed at block 1016. In an embodiment, the default annotation may indicate that the annotation module 148/178/198 was unable to determine, at block 1008, an annotation that provides explanatory information regarding a meaning of the identified symbol. In an embodiment, the default annotation may include (or may also act as) a link to user documentation for the application module 152/180/194. In another embodiment, the default annotation may include (or may also act as) a link to an external resource for determining a meaning of the symbol, such as the Wolfram Alpha® computational knowledge engine.

Referring now to FIGS. 2 and 10, in an embodiment, the method 1000 is implemented entirely by the annotation module 178. In another embodiment, the method 100 is implemented partially by the annotation module 178 and partially by the annotation module 198. For example, in an embodiment, the annotation module 178 may send a document containing the software code to the annotation module 198, and the annotation module 198 may analyze the document and perform blocks 1004, 1008, and 1012. Then, the annotation module 178 may perform block 1016. In one embodiment, the annotation module 198 may revise the document by adding the annotations to the document, and send the revised document to the annotation module 178. In another embodiment, the annotation module 198 may determine location information that indicates where annotations are to be added to the document, and may send indications of the annotations and location information corresponding to the annotations to the annotation module 178. Then, the annotation module 178 may add annotations to the document using the indications of the annotations and location information received from the annotation module 198.

In another embodiment, the annotation module 178 may perform block 1004, and may send indications of identified symbols to the annotation module 198. Then, the annotation module 198 may perform block 1008, and may send indications of corresponding annotations to the annotation module 178. Then, the annotation module 178 may perform blocks 1012 and 1016.

At least some of the various blocks, operations, and techniques described above may be implemented utilizing hardware, a processor executing firmware instructions, a processor executing software instructions, or any combination thereof. When implemented utilizing one or more processors executing software or firmware instructions, the software or firmware instructions may be stored in any tangible, non-transitory computer readable media such as a magnetic disk, an optical disk, a RAM, a ROM, a flash memory, a magnetic tape, etc. The software or firmware instructions may include machine readable instructions that, when executed by the one or more processors, cause the one or more processors to perform various acts.

When implemented in hardware, the hardware may comprise one or more of i) discrete components, ii) one or more integrated circuits, iii) one or more application-specific integrated circuits (ASICs), etc.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

What is claimed is:

1. A method, comprising:
analyzing, at one or more processors, software code in a document to identify one or more symbols in the software code, the one or more symbols corresponding to a defined software syntax i) that a computational application is preconfigured to recognize, and/or ii) that are defined by a software language;
for each of one or more identified symbols, at one or more processors,
determining a corresponding annotation that conveys a meaning of the identified symbol,
determining a location within the document to display the annotation so that the annotation, when displayed, is visually associated with the identified symbol, and
displaying the annotation at the location.

2. The method of claim 1, wherein the one or more symbols comprise one or more keywords i) that the computational application is preconfigured to recognize, and/or ii) that are defined by a software language.

3. The method of claim 1, wherein the one or more symbols comprise a combination of one or more alphanumeric characters i) that the computational application is preconfigured to recognize, and/or ii) that are defined by a software language.

4. The method of claim 1, wherein a first symbol among the one or more identified symbols corresponds to a plurality of possible meanings; and
wherein determining the corresponding annotation that conveys the meaning of the first symbol comprises, at one or more processors, selecting the meaning of the first symbol from the plurality of possible meanings.

5. The method of claim 4, further comprising:
analyzing a context of the first symbol within the software code, and
wherein selecting the meaning of the first symbol from the plurality of possible meanings is based on the analysis of the context of the first symbol within the software code.

6. The method of claim 1, wherein:
determining, for each of one or more identified symbols, the corresponding annotation that conveys the meaning of the identified symbol comprises determining a first annotation corresponding to a first symbol among the one or more identified symbols and determining a second annotation corresponding to a second symbol among the one or more identified symbols;
the method further comprises determining whether, when fully displayed, the first annotation at a first location will visually overlap with the second annotation at a second location; and
displaying, for each of one or more identified symbols, the annotation at the location comprises
when it is determined that, when fully displayed, the first annotation at the first location will visually overlap with the second annotation at the second location, displaying only a portion of the first annotation at the first location so that display of the portion of the first annotation will not visually overlap with the second annotation at the second location.

7. The method of claim 6, further comprising:
determining, at one or more processors, whether a graphical user interface pointer is over the first annotation; and
when it is determined that the graphical user interface pointer is over the first annotation, displaying the entire first annotation at the first location so that display of the first annotation visually overlaps with the second annotation at the second location.

8. The method of claim 6, further comprising:
determining, at one or more processors, whether the first annotation was selected with a user interface mechanism; and
when it is determined that the first annotation was selected with the user interface mechanism, displaying the entire first annotation at the first location so that display of the first annotation visually overlaps with the second annotation at the second location.

9. The method of claim 1, wherein:
a first symbol among the one or more identified symbols comprises a keyword using word components from a first natural language; and
a first annotation corresponding to the first symbol comprises one or more words from a second natural language.

10. The method of claim 9, wherein:
the first natural language is English; and
the second natural language is selected from a group consisting of Arabic, Chinese, Dutch, French, German, Greek, Hebrew, Hindi, Indonesian, Italian, Japanese, Korean, Persian, Portuguese, Russian, Spanish, Turkish, and Urdu.

11. The method of claim 1, wherein:
a first annotation corresponding to a first symbol among the one or more identified symbols comprises a graphical object that visually conveys a meaning of the first symbol.

12. A tangible, non-transitory computer readable medium, or media, storing machine readable instructions that, when executed by one or more processors, cause the one or more processors to:
analyze software code in a document to identify one or more symbols in the software code, the one or more symbols corresponding to a defined software syntax i) that a computational application is preconfigured to recognize, and/or ii) that are defined by a software language;
for each of one or more identified symbols,
determine a corresponding annotation that conveys a meaning of the identified symbol,
determine a location within the document to display the annotation on a display device so that the annotation, when displayed on the display device, is visually associated with the identified symbol, and
cause the annotation to be displayed on the display device at the location.

13. The computer readable medium, or media, of claim 12, wherein the one or more symbols comprise one or more keywords i) that the computational application is preconfigured to recognize, and/or ii) that are defined by a software language.

14. The computer readable medium, or media, of claim 12, wherein the one or more symbols comprise a combination of one or more alphanumeric characters i) that the computational application is preconfigured to recognize, and/or ii) that are defined by a software language.

15. The computer readable medium, or media, of claim 12, wherein a first symbol among the one or more identified symbols corresponds to a plurality of possible meanings; and
wherein the computer readable medium, or media, further stores machine readable instructions that, when executed by one or more processors, cause the one or more processors to select the meaning of the first symbol from the plurality of possible meanings.

16. The computer readable medium, or media, of claim 15, further storing machine readable instructions that, when executed by one or more processors, cause the one or more processors to:
analyze a context of the first symbol within the software code; and
select the meaning of the first symbol from the plurality of possible meanings based on the analysis of the context of the first symbol within the software code.

17. The computer readable medium, or media, of claim 12, further storing machine readable instructions that, when executed by one or more processors, cause the one or more processors to:
determine a first annotation corresponding to a first symbol among the one or more identified symbols;
determine a second annotation corresponding to a second symbol among the one or more identified symbols;
determine whether, when fully displayed on the display device, the first annotation at a first location will visually overlap with the second annotation at a second location; and
when it is determined that, when fully displayed, the first annotation at the first location will visually overlap with the second annotation at the second location, display on the display device only a portion of the first annotation at the first location so that display of the portion of the first annotation will not visually overlap with the second annotation at the second location.

18. The computer readable medium, or media, of claim 17, further storing machine readable instructions that, when executed by one or more processors, cause the one or more processors to:
determine whether a graphical user interface pointer is over the first annotation; and
when it is determined that the graphical user interface pointer is over the first annotation, display the entire first annotation on the display device at the first location so that display of the first annotation visually overlaps with the second annotation at the second location.

19. The computer readable medium, or media, of claim 17, further storing machine readable instructions that, when executed by one or more processors, cause the one or more processors to:
determine whether the first annotation was selected with a user interface mechanism; and
when it is determined that the first annotation was selected with the user interface mechanism, display the entire first annotation at the first location so that display of the first annotation visually overlaps with the second annotation at the second location.

20. The computer readable medium, or media, of claim 12, wherein:
a first symbol among the one or more identified symbols comprises a keyword using word components from a first natural language; and
a first annotation corresponding to the first symbol comprises one or more words from a second natural language.

21. The computer readable medium, or media, of claim 12, wherein:
a first annotation corresponding to a first symbol among the one or more identified symbols comprises a graphical object that visually conveys a meaning of the first symbol.

22. A system, comprising:
one or more processors; and
one or more memories coupled to the one or more processors, the one or more memories storing machine readable instructions that, when executed by one or more processors, cause the one or more processors to:
analyze software code in a document to identify one or more symbols in the software code, the one or more symbols corresponding to a defined software syntax i) that a computational application is preconfigured to recognize, and/or ii) that are defined by a software language; and
for each of one or more identified symbols,
determine a corresponding annotation that conveys a meaning of the identified symbol,
determine a location within the document to display, on a display device, the annotation so that the annotation, when displayed, is visually associated with the identified symbol, and
cause the annotation to be displayed on the display device at the location.

23. The system of claim 22, wherein the one or more symbols comprise one or more keywords i) that the computational application is preconfigured to recognize, and/or ii) that are defined by a software language.

24. The system of claim 22, wherein the one or more symbols comprise a combination of one or more alphanumeric characters i) that the computational application is preconfigured to recognize, and/or ii) that are defined by a software language.

25. The system of claim 22, wherein a first symbol among the one or more identified symbols corresponds to a plurality of possible meanings; and
wherein the one or more memories further store machine readable instructions that, when executed by one or more processors, cause the one or more processors to select the meaning of the first symbol from the plurality of possible meanings.

26. The system of claim 25, wherein the one or more memories further store machine readable instructions that, when executed by one or more processors, cause the one or more processors to:
analyze a context of the first symbol within the software code; and
select the meaning of the first symbol from the plurality of possible meanings based on the analysis of the context of the first symbol within the software code.

27. The system of claim 22, wherein the one or more memories further store machine readable instructions that, when executed by one or more processors, cause the one or more processors to:
determine a first annotation corresponding to a first symbol among the one or more identified symbols;
determine a second annotation corresponding to a second symbol among the one or more identified symbols;
determine whether, when fully displayed on the display device, the first annotation at a first location will visually overlap with the second annotation at a second location; and
when it is determined that, when fully displayed on the display device, the first annotation at the first location will visually overlap with the second annotation at the second location, display only a portion of the first annotation on the display device at the first location so that display of the portion of the first annotation will not visually overlap with the second annotation at the second location.

28. The system of claim 27, wherein the one or more memories further store machine readable instructions that, when executed by one or more processors, cause the one or more processors to:
determine whether a graphical user interface pointer is over the first annotation; and
when it is determined that the graphical user interface pointer is over the first annotation, display the entire first annotation on the display device at the first location so that display of the first annotation visually overlaps with the second annotation at the second location.

29. The system of claim 27, wherein the one or more memories further store machine readable instructions that, when executed by one or more processors, cause the one or more processors to:
determine whether the first annotation was selected with a user interface mechanism; and
when it is determined that the first annotation was selected with the user interface mechanism, display the entire first annotation on the display device at the first location so that display of the first annotation visually overlaps with the second annotation at the second location.

30. The system of claim 22, wherein:
a first symbol among the one or more identified symbols comprises a keyword using word components from a first natural language; and
a first annotation corresponding to the first symbol comprises one or more words from a second natural language.

31. The system of claim 32, wherein:
a first annotation corresponding to a first symbol among the one or more identified symbols comprises a graphical object that visually conveys a meaning of the first symbol.

32. The system of claim 22, wherein:
the one or more processors include a first processor at a user computer and a second processor at a server;
the one or more memories include a first memory at the user computer and a second memory at the server;
the user computer and the server are communicatively coupled via a network; and
the user computer includes, or is coupled to, the display device.

33. The system of claim 22, wherein:
the one or more processors are at a server;
the one or more memories are at the server;
the server is communicatively coupled to a user computer via a network; and
the user computer includes, or is coupled to, the display device.

34. The system of claim 22, wherein:
the one or more processors are at a user computer;
the one or more memories are at the user computer; and
the system further comprises a display device of, or coupled to, the user computer.
